(19) United States
(12) Patent Application Publication
(10) Pub. No.: US 2026/0184193 A1
(43) Pub. Date: Jul. 2, 2026

(54) SYSTEM AND METHOD FOR METHOD OF OPTIMIZING NVH AND EFFICIENCY OF ELECTRIC POWERTRAIN

(71) Applicant: Cummins Inc., Columbus, IN (US)

(72) Inventor: John P. O'Brien, Columbus, IN (US)

(21) Appl. No.: 19/006,112

(22) Filed: Dec. 30, 2024

(51) Int. Cl. B60L 15/20; B60L 3/00

(52) U.S. Cl. CPC B60L 15/2045; B60L 3/0092; B60L 2210/40; B60L 2240/12; B60L 2240/62; B60L 2270/42

(57) ABSTRACT

In some implementations, methods may include receiving an indication of a dominant disturbance associated with operation of a first component of the electrified vehicle, the dominant disturbance having a dominant noise level associated therewith. In addition, the methods may include adjusting operation of a second component of the electrified vehicle having a secondary noise level associated therewith at least so long as the secondary noise level is less than the dominant noise level such that performance of the electrified vehicle is optimized without detrimentally affecting the sensory feedback associated with the performance.

### TECHNICAL FIELD

The present disclosure relates to energy management systems in electrified vehicles, specifically to a system and method for generating an energy overview that facilitates the optimized allocation of accessory power to enhance cabin comfort while maintaining powertrain efficiency.

### BACKGROUND

Electrified vehicles (EVs), including battery electric vehicles (BEVs), hybrid electric vehicles (HEVs), and plug-in hybrid electric vehicles (PHEVs), rely on efficient energy management to ensure optimal performance. While these vehicles integrate advanced systems to manage propulsion energy, there remains a need for systems that address the allocation of energy to accessory loads, such as heating, ventilation, and air conditioning (HVAC), in a manner that does not compromise overall efficiency. Current systems often lack the ability to dynamically present energy usage data for accessories in a user-friendly format or to integrate seamlessly with the vehicle's powertrain to optimize energy usage for enhanced cabin comfort.

### SUMMARY

The present disclosure provides a system and method for generating an energy overview for accessory power usage in electrified vehicles. The system comprises a control module integrated with the vehicle's powertrain, including its high- and low-voltage circuitry, that monitors and analyzes energy flow. This module generates a detailed energy overview accessible to the user, which highlights energy availability and usage trends. The system dynamically allocates energy for accessory power, such as cabin climate control, based on real-time data from the powertrain while preserving propulsion and battery efficiency. Additionally, the system includes an interface that allows users to adjust accessory power settings to prioritize comfort or efficiency.

In Example 1, a method of dynamically optimizing performance and sensory feedback of an electrified vehicle, the method comprising: receiving an indication of a dominant disturbance associated with operation of a first component of the electrified vehicle, the dominant disturbance having a dominant noise level associated therewith; and adjusting operation of a second component of the electrified vehicle having a secondary noise level associated therewith at least so long as the secondary noise level is less than the dominant noise level such that performance of the electrified vehicle is optimized without detrimentally affecting the sensory feedback associated with the performance.

In Example 2, the method as Example 1 describes, wherein the adjusting is subject to a safety criterion associated with vehicle safety conditions and vehicle safety operations.

In Example 3, the method as either of Examples 1 or 2 describe, wherein the vehicle safety operations includes at least one of a passenger pickup operation, a signage deployment operation, and a safety component deployment operation.

In Example 4, the method as any of Examples 1-3 describe, wherein the safety criterion is related to at least one of a vehicle speed and a vehicle location.

In Example 5, the method as any of Examples 1-4 describe, wherein the vehicle safety conditions include at least one of low noise during low-speed operation of the electrified vehicle, a charging operation to charge the electrified vehicle, and a location or proximity to a safety zone or safety vehicle.

In Example 6, the method as any of Examples 1-5 describe, wherein the adjusting operation of the second component of the electrified vehicle having the secondary noise level associated therewith includes causing the second component to operate at a level that produces otherwise more objectionable noise than before the adjustment.

In Example 7, the method as any of Examples 1-6 describe, wherein either of the first and second components is a traction component of the electrified vehicle and the other of the first and second components is an inverter of the electrified vehicle.

In Example 8, the method as any of Examples 1-7 describe, wherein the adjusting causes the performance of the electrified vehicle to be optimized to an operation mode of the electrified vehicle.

In Example 9, the method as any of Examples 1-8 describe, wherein the operation mode of the electrified vehicle is selectable by an operator of the electrified vehicle during operation of the electrified vehicle.

In Example 10, the method as any of Examples 1-9 describe, wherein the operation mode of the electrified vehicle is at least one of an efficiency mode, a performance mode, an NVH mode, and a balanced mode.

In Example 11, the method as any of Examples 1-10 describe, wherein the efficiency mode is a high-efficiency mode, the performance mode is a high-performance mode, and the NVH mode is a low-noise mode.

In Example 12, a system to promote real-time operational adjustments of a first component that is operationally connected with a power source in concert with a second component that is operationally connected with the power source, the first component operating so as to produce a dominant noise level relative to the second component, the system being configured to adjust an operation of the second component based on both the dominant noise level and a sensory feedback criterion.

In Example 13, the system as Example 12 describes, wherein the system is integrable into an electrified vehicle, and wherein either of the first and second components is a traction component of the electrified vehicle and the other of the first and second components is an inverter of the electrified vehicle, and the adjustment includes causing the second component to operate at a level that produces otherwise more objectionable noise than before the adjustment.

In Example 14, the system as either of Examples 12 or 13 describe, wherein the adjustment is subject to a safety criterion associated with vehicle safety conditions and vehicle safety operations.

In Example 15, the system as any of Examples 12-14 describe, wherein the power source is an electrified vehicle, wherein the adjustment causes the performance of the electrified vehicle to be optimized to an operation mode of the electrified vehicle, and wherein the operation mode of the electrified vehicle is selectable by the operator of the electrified vehicle during operation of the electrified vehicle.

In Example 16, the system as any of Examples 12-15 describe, wherein the system is integrated into the electrified vehicle, wherein the dominant noise level is caused by a driver demand, and wherein a sensory feedback criterion to which the adjustments are tailored conforms to an NVH standard or regulation for the electrified vehicle.

In Example 17, the system as any of Examples 12-16 describe, wherein the power source is a charging station for an electrified vehicle or a generator.

In Example 18, a controller configured to monitor sensory feedback of a power source and energy flow through a circuitry that operatively connects components of the power source, and dynamically allocate energy from the power source to the components based on both a dominant noise level among components of the power source and a sensory feedback criterion.

In Example 19, the controller as Example 18 describes, wherein the controller uses a model to dynamically allocate the energy according to a predetermined mapping of the components.

In Example 20, the controller as either of Examples 18 or 19 describe, wherein the model is configured to tailor the allocations based on at least one of input at an interface for displaying real-time energy usage, input at the interface to select a desired operation mode of the power source, input at the interface to select a desired sensory feedback level of the power source, and historical trends of operation the inputs or operation of the power source.

### BRIEF DESCRIPTION OF THE DRAWINGS

FIG. 1 is a schematic diagram of a dual-axle multi-mode adjustable hybrid vehicle system with integrated front axle;

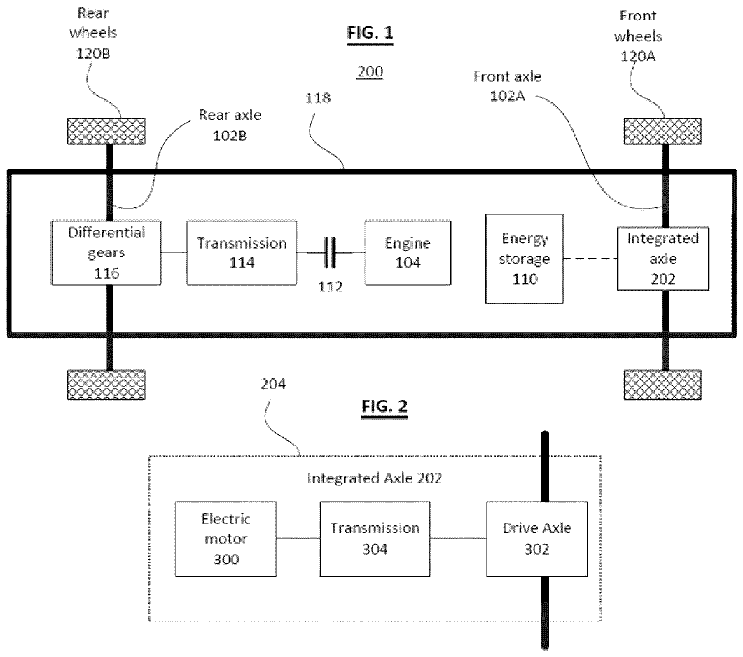

FIG. 2 is a schematic diagram of an integrated axle;

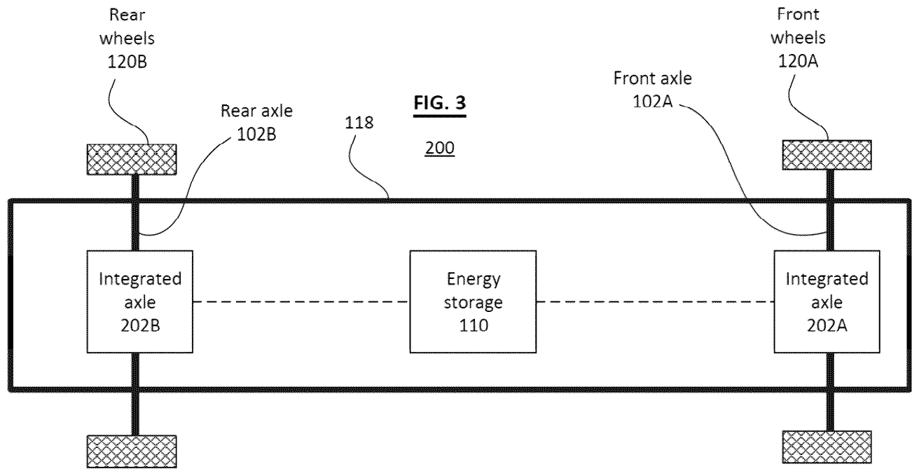

FIG. 3 is a schematic diagram of another dual-axle multi-mode adjustable hybrid vehicle system with integrated front axle;

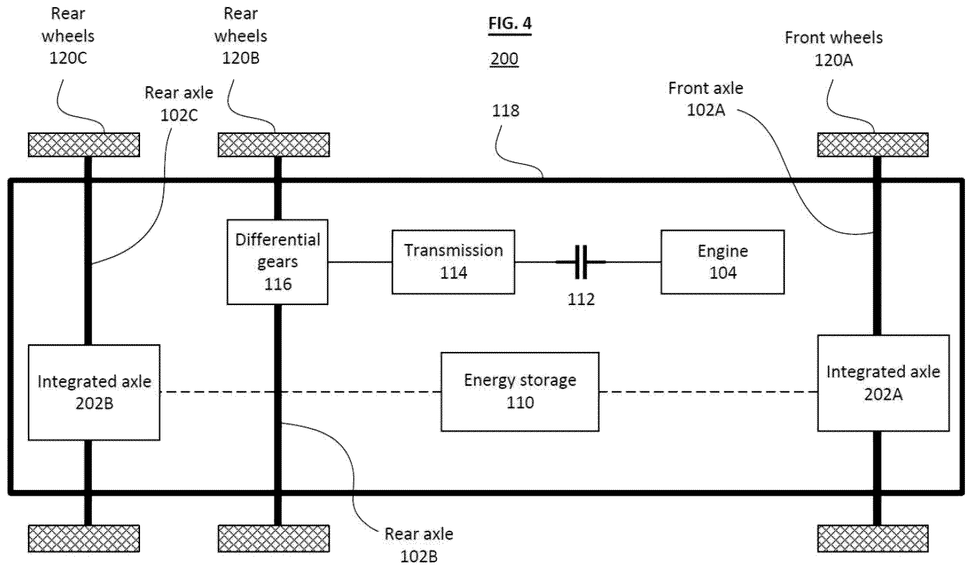

FIG. 4 is a schematic diagram of an example of a three-axle multi-mode adjustable hybrid vehicle system with integrated front axle;

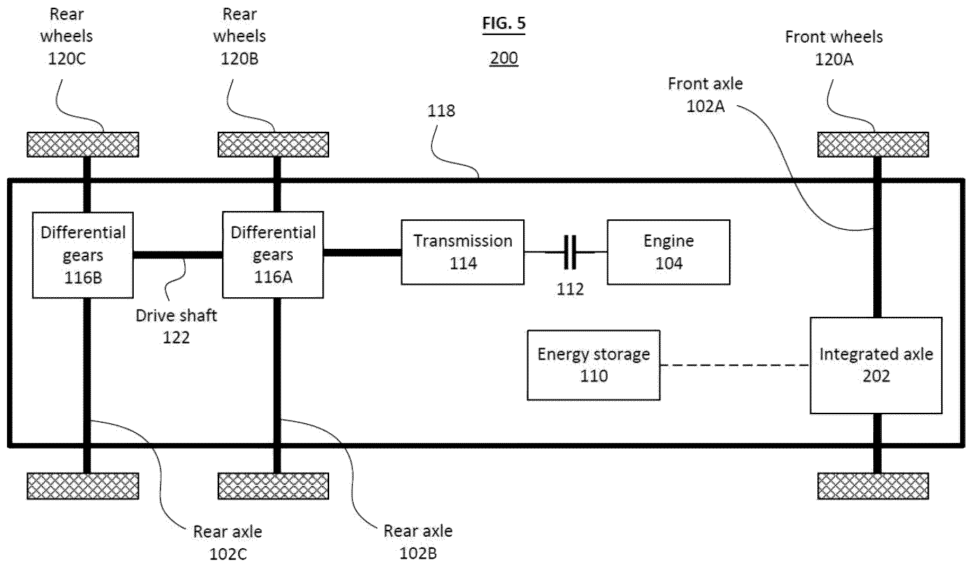

FIG. 5 is a schematic diagram of an example of a three-axle multi-mode adjustable hybrid vehicle system with integrated front axle;

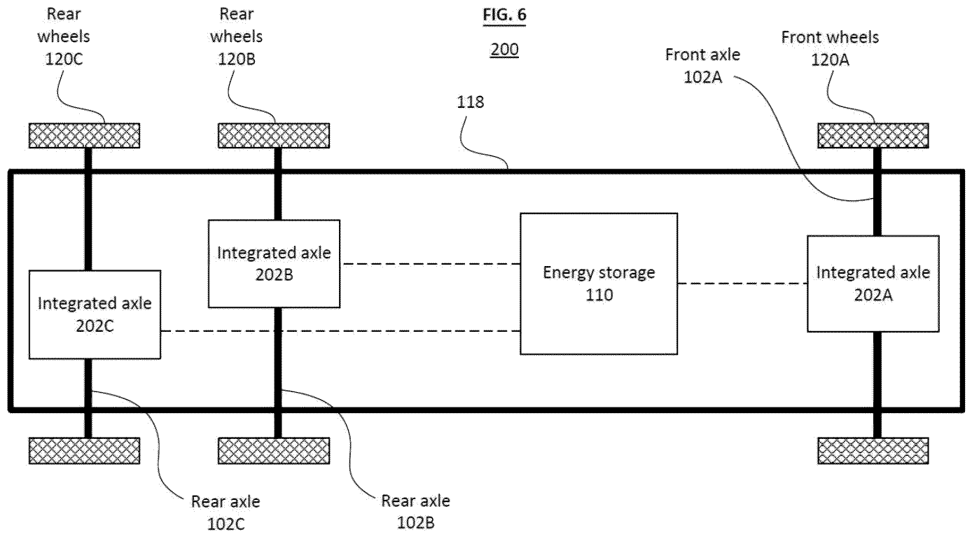

FIG. 6 is a schematic diagram of an example of a three-axle multi-mode adjustable hybrid vehicle system with integrated front axle;

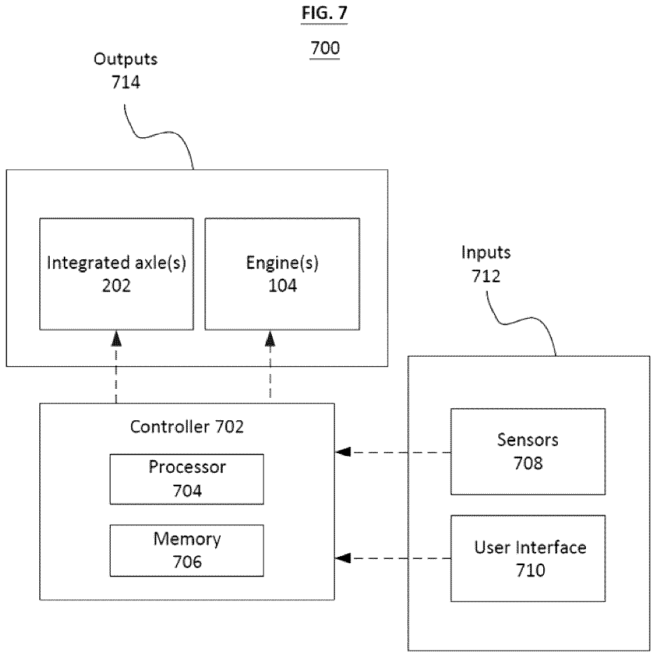

FIG. 7 is a schematic diagram of a controller operatively coupled with other components of the system; and

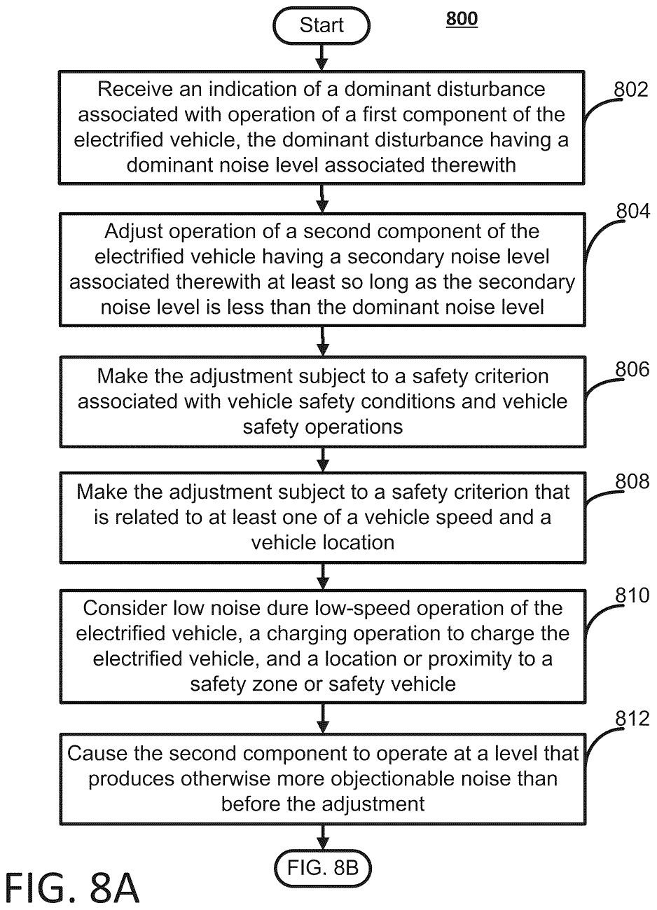

FIGS. 8A and 8B together show a flowchart of a method of optimizing a power source, according to principles of the present disclosure. 3

### DETAILED DESCRIPTION

For purposes of promoting an understanding of the principles of the present disclosure, reference is now made to the embodiments illustrated in the drawings, which are described below. The exemplary embodiments disclosed herein are not intended to be exhaustive or to limit the disclosure to the precise form disclosed in the following detailed description. Rather, these exemplary embodiments were chosen and described so that others skilled in the art may utilize their teachings. It is not beyond the scope of this disclosure to have a number (e.g., all) the features in a given embodiment to be used across all embodiments.

Noise, Vibration, and Harshness (NVH) in electrified vehicles is the cumulative result of various sound and vibration sources from multiple components within the drivetrain and auxiliary systems. Unlike traditional internal combustion engines (ICE), which generate dominant and often masking noise, electrified units, such as electric motors, inverters, and cooling systems, operate with unique acoustic signatures. For instance, electric motors produce tonal noises at specific frequencies related to their rotational speed and switching frequency in the inverter. Cooling fans and pumps add broadband noise, while auxiliary systems like HVAC compressors contribute additional tonal or impulsive sounds. These distinct sources collectively define the NVH profile, with each component's contribution varying in amplitude and frequency range based on operational conditions.

The relative difference in noise levels between components significantly influences how individual sounds are perceived in the overall NVH spectrum. In electrified vehicles, the absence of a loud ICE engine often reveals subtler noises that would otherwise be masked. For instance, the high-frequency tonal whine of the inverter or the clicking of a relay might become noticeable due to the relatively low noise levels of the drivetrain. Conversely, certain components like cooling fans may dominate in specific operating modes, such as during high thermal loads, masking less prominent sounds like the faint humming of the electric motor. This dynamic interplay between noise sources creates a complex acoustic environment that must be carefully managed to meet NVH performance standards.

The masking effect plays a useful role in shaping the NVH experience, as louder or more broadband noises can obscure quieter or higher-frequency sounds. This effect can be advantageous in certain scenarios, such as using cooling fan noise to mask high-pitched inverter whines. However, it can also pose challenges, as poorly managed masking may lead to the perception of unpleasant or distracting sounds that stand out during low-noise conditions, such as when the vehicle is idling or coasting. Understanding the relative dominance and masking effects of different noise sources allows engineers to design targeted NVH mitigation strategies, such as soundproofing, active noise cancellation, or frequency optimization, to enhance overall cabin comfort.

However, this masking presents an opportunity to increase the performance level of otherwise masked components to lead to an overall better experience for an operator depending on the desired operating mode. For instance, if the traction motor is operated at a noise level that masked the operation of an inverter, in a certain drive mode, performance of the inverter can be adjusted so long as the noise level of the inverter remains less than that of the traction motor. In examples, control/calibration tradeoffs are made during development and are fixed during vehicle operation. Other examples are contemplated where this may not be the case.

Principles of the present disclosure generally relates to a system and method of controlling powertrain and non-powertrain noise sources and conditions for optimizing NVH and efficiency of electric powertrain such as real-time adjustment of the invertor based on noise source and multi-level control strategy for optimizing traction system performance, efficiency, and noise emission. In this regard, the system and methods can facilitate coordination of powertrain and non-powertrain noise sources and conditions in order to optimize traction (or other powertrain component) operation for the given condition. Control/calibration tradeoffs can be made during development and can be updated, adjusted, or fixed during vehicle operation (e.g., via systems service updates and/or onboard or remote intelligent models). In this light, these systems and methods provide incrementally better efficiency, performance or NVH at a vehicle level.

The noise signature of an EV significantly differs from that of traditional ICE vehicles due to the unique characteristics of electric powertrains, which affect NVH levels. Unlike ICE vehicles, EVs generally produce less engine noise but can exhibit high-frequency sounds primarily originating from the electric motor, power electronics, and auxiliary systems such as cooling fans and compressors. The electric motor generates a distinct high-pitched whine, especially noticeable during acceleration and regenerative braking, typically in the frequency range of 2 kHz to 8 kHz. Additionally, the switching of power electronics components, such as inverters, generates electromagnetic noise, contributing to the vehicle's overall noise signature. Auxiliary systems, including cooling fans, air conditioning compressors, and brake systems, can produce additional noise that may be more noticeable in the quieter environment of an EV.

Vibration in EVs is influenced by the electric motor, drivetrain, and road interactions. The rotational vibrations from the electric motor and driveline components can propagate through the vehicle structure, typically at higher frequencies compared to those in ICE vehicles. Furthermore, interactions with the road surface generate vibrations transmitted through the suspension and chassis, which, due to the reduced masking effect from engine vibrations, can be more perceptible in EVs. Harshness, which refers to the subjective perception of roughness or abruptness in the vehicle's response to road inputs and operating conditions, is influenced by the rapid torque delivery of electric motors leading to abrupt changes in acceleration and deceleration. This can be perceived as harshness by occupants. Additionally, the design and tuning of the vehicle's suspension system play a useful role in managing harshness, requiring specific tuning to balance the reduced noise and vibration levels with the need for a comfortable ride.

To enhance NVH performance in electrified vehicles, manufacturers employ various strategies. Acoustic insulation is used to add sound-absorbing materials and insulate components to reduce high-frequency noise from the electric motor and power electronics. Active noise control systems generate counter-noise to cancel out undesirable sounds. Vibration dampening techniques, using advanced materials and engineering practices, help minimize the transmission of vibrations through the vehicle structure. Optimized component design, including engineering motor mounts, powertrain components, and auxiliary systems, aims to minimize their contribution to noise and harshness. By understanding and addressing these NVH characteristics, manufacturers can significantly enhance the acoustic comfort and overall driving experience of EVs.

NVH encompass a variety of elements that contribute to the overall acoustic and tactile experience in a vehicle. NVH can include tonal sounds, such as the noise generated by the engine or powertrain, which are often characterized by specific frequencies and pitches. These sounds can be particularly noticeable during acceleration or when the vehicle is under load. Additionally, broadband sounds, such as road noise and wind noise, contribute to the vehicle's acoustic environment. Road noise arises from the interaction between the tires and the road surface, while wind noise is generated by the airflow around the vehicle's body at higher speeds.

Tactile feedback, another useful aspect of NVH, includes the sensations felt by occupants due to bumps from the suspension or vibrations from the engine and other components. These tactile responses can significantly impact the perceived quality and comfort of the vehicle. Through NVH analysis, engineers can systematically identify the sources of various sounds and vibrations, determining whether they are beneficial or annoying to the occupants. This detailed analysis allows for the strategic reduction of unwanted noises and the enhancement of sounds that contribute positively to the driving experience.

In the automotive industry, measuring and optimizing NVH is a useful aspect of vehicle design validation. By employing sophisticated tools and methodologies, engineers can simulate and evaluate different scenarios to understand how various design choices impact NVH characteristics. This process includes the use of advanced sensors, microphones, and data analysis techniques to capture and analyze the acoustic and vibrational behavior of the vehicle. The insights gained from NVH analysis enable engineers to make informed decisions about material selection, component design, and structural modifications to achieve the desired balance of quietness and tactile feedback. Ultimately, a well-executed NVH strategy enhances the overall refinement and appeal of the vehicle, contributing to a more enjoyable and comfortable driving experience for the occupants.

### (a) System Overview

The system integrates with the electrified vehicle's powertrain, comprising a battery pack, inverter, electric motor, and auxiliary systems. It interacts with both high-and low-voltage circuits to ensure seamless energy flow management. The system's control module communicates with the powertrain control unit (PCU) to access real-time data on energy consumption and availability. It processes this data to generate an energy overview, which is displayed to the user via the vehicle's infotainment system.

The system coordinates various components of the electrified vehicle in concert with respect to NVH so long as certain criteria are met. For instance, fan (e.g., blower fans, cooling fans, etc.) can be optimized to operate at a low noise level during low or no speed conditions or during specific vehicle operations (such as passenger pickup). In addition, or in alternative, the present disclosure provides system level coordination of traction system noise/efficiency optimization and, if applicable, hybrid prime mover (e.g., ICE, HCE, or Fuel Cell) with vehicle level noise factors (such as speed, wind, road/tire noise, and HVAC usage) to optimize both the energy/fuel consumption and the noise signature of the overall vehicle.

The control of inverters plays an important role in shaping the performance, efficiency, and NVH emissions of a traction system, whether in a frame-mounted central drive machine or an integrated eAxle configuration. The system can employ calibration and control tradeoffs of the inverter controls. These tradeoffs can be mapped, and multilevel controls implemented to operate the traction system in certain modes, such as highest efficiency, highest performance, or lowest noise. This multi-level control can be coordinated with other system or vehicle components to meet different vehicle level optimization goals in different operating conditions or environments.

In the context of NVH, while the overall noise amplitude remains constrained by strict regulatory limits or customer expectations, the focus on sound quality may diminish as a secondary consideration. Noise amplitude, as a measurable and more directly impactful factor, often takes precedence in ensuring compliance and user acceptability. Sound quality, which involves subjective psychoacoustic attributes such as tonal balance, sharpness, or roughness, may receive less attention when absolute noise levels dominate design priorities. This shift can also stem from resource allocation, as efforts to further enhance sound quality might yield diminishing returns under tight amplitude constraints. Furthermore, engineering tradeoffs often prioritize reducing noise amplitude over fine-tuning its perceptual characteristics, especially when competing performance objectives, such as efficiency or durability, are at stake. Consequently, sound quality considerations may be deprioritized within NVH optimization efforts when stringent amplitude limits are the primary design driver.

At elevated speeds, road and tire noise often become the predominant contributors to a vehicle's overall internal and external noise signature. These broadband noises can overshadow other acoustic sources, such as those originating from cooling fans, inverters, or traction machines. This masking effect occurs because the intensity and frequency content of road and tire noise dominate the acoustic environment, reducing the perceptibility of secondary noise sources. As a result, the contributions of these components to the vehicle's NVH characteristics may be less noticeable or even rendered acoustically negligible under such operating conditions. Therefore, it may be advantageous to operate the traction machine in a higher performance or higher efficiency mode and emit higher/more objectionable noise during these conditions (e.g., while they can be masked by the dominant noise). Other cabin noise sources (such as radio or HVAC usage) could also be communicated to the system controller, shifting the controls tradeoff from optimized noise to optimized efficiency.

In a hybrid ICE powertrain, the operation of the ICE introduces combustion noise that often becomes a significant contributor to the vehicle's overall noise signature. Under these conditions, the acoustic characteristics of the ICE typically dominate over other noise sources. Simultaneously, system priorities may shift toward optimizing fuel efficiency and minimizing emissions, reflecting the importance of these performance metrics during ICE operation. This dynamic can highlight the interplay between NVH characteristics and broader engineering goals, as managing combustion noise must align with the stringent demands of environmental and energy performance standards. Therefore, as above, it may be advantageous to operate the traction machine in a higher performance or higher efficiency mode and emit higher/more objectionable noise during these conditions.

In certain vehicle applications, such as school buses or transit buses, additional operational considerations, such as the presence of public passengers, may influence the allowable balance between efficiency and noise optimization. These inputs provide context-sensitive criteria for tailoring NVH performance to specific use cases. For instance, in environments where passenger comfort is important, noise reduction may take precedence over efficiency gains. Conversely, when operational efficiency is prioritized, such as during periods of low passenger occupancy, the tolerance for higher noise levels may increase. This adaptive approach enables optimization strategies that account for the unique demands of the vehicle's operating conditions and user context.

Additionally, or in alternative, location-based optimization can be employed in bus applications to further enhance acoustic performance. For example, when the bus approaches a designated stop or when the stop-arm is deployed, the system may automatically adjust various noise-producing components. One such strategy involves reducing or turning off fans to minimize their acoustic contribution, ensuring that the vehicle's noise signature is as low as possible during sensitive moments, such as when passengers are embarking or disembarking. This embodiment of NVH optimization leverages both the vehicle's operational context and its specific location to improve the overall passenger experience while balancing performance objectives.

In the case of BEVs, operating modes such as high-power charging can also introduce challenges in NVH optimization. During high-power charging, the increased demand for battery cooling typically necessitates higher heat exchanger cooling fan speeds to effectively manage thermal load. This increased fan speed, while essential for maintaining battery health and performance, can lead to elevated noise levels, adding to the vehicle's overall acoustic footprint. As such, BEV systems must balance the need for effective thermal management with the goal of minimizing noise, particularly in environments where quiet operation is a priority. While traction is most likely disabled for any such stationary charging event, other onboard systems that can take advantage of this same tradeoff could increase capability or efficiency in exchange for higher noise levels, shortening charge times or reducing grid energy consumption during the charge event.

The system can be referred to elsewhere herein as an energy overview system. The energy overview system is designed to provide a comprehensive understanding of a vehicle's accessory power consumption and its relationship to overall energy usage, while also managing the distribution of energy across high-voltage and low-voltage systems. It continuously monitors the power consumption of various vehicle accessories, such as HVAC systems, lighting, and infotainment, offering real-time insights into how much energy these components are using. This data is processed by the system's control module, which combines it with other relevant information, such as the battery state of charge (SOC), driving conditions, regenerative braking rates, and the distribution of energy across both high-and low-voltage systems. By tracking real-time usage, the system allows for immediate adjustments to optimize energy efficiency while minimizing noise levels associated with both high-and low-voltage components. Monitoring as used herein can be continuous or intermittent.

In addition to real-time monitoring, the system collects historical data to analyze trends in accessory power usage over time. By studying these trends, the system can predict how different accessory usage patterns will affect the vehicle's energy availability and consumption under various conditions. This historical analysis helps identify periods of high energy consumption and potential inefficiencies, as well as noise emissions, especially from high-voltage systems such as inverters or cooling fans used for powertrain components. The system can take proactive measures to improve both efficiency and NVH performance by adjusting accessory power use when high-voltage systems are generating more noise or consuming excessive energy, thus maintaining a quiet cabin environment.

The energy overview system goes beyond data collection by utilizing sophisticated algorithms to generate actionable insights that help optimize energy management. These algorithms analyze the data and generate recommendations for the most efficient use of energy while considering both power usage and noise emissions from the vehicle's systems. For example, when the SOC is low, the system may suggest reducing HVAC system usage to conserve battery power for propulsion. Additionally, the system can adjust the allocation of energy to high-voltage systems to ensure that energy consumption from components like inverters or high-power cooling fans does not compromise both the vehicle's range and noise levels. By minimizing unnecessary power draw and controlling high-voltage system noise, the system ensures a quieter and more efficient vehicle operation.

A key feature of the system is its integration with the vehicle's powertrain, which includes both high-voltage components, such as the battery, inverter, and electric motor, and low-voltage accessories, such as lighting and infotainment. This integration enables the system to monitor energy flow between these core components and adjust accessory power usage accordingly. For instance, when the powertrain requires more energy for propulsion, the system can dynamically reduce the power allocated to non-essential low-voltage accessories. Simultaneously, it can adjust the energy consumption of high-voltage components, such as cooling fans or inverters, that are prone to generating higher noise levels. This ensures that the vehicle maintains optimal performance while managing both power consumption and noise emissions, creating a balanced driving experience.

The system's integration with the powertrain allows for dynamic and real-time adjustments of accessory power usage based on vehicle performance and energy requirements. For example, during highway driving, when regenerative braking is minimal and the vehicle's energy needs are high, the system will limit accessory power usage to maximize the available energy for propulsion. In urban driving, where frequent regenerative braking occurs, the system may increase the power available to accessories, utilizing the extra energy recovery to ensure optimal performance without draining the battery. The system also takes into account the noise levels generated by high-voltage components during these dynamic adjustments, reducing the noise produced by high-voltage systems, such as cooling fans or inverters, when possible, to ensure a quieter cabin environment.

User adjustability is another useful aspect of the system, providing the driver with control over how energy is allocated to various vehicle accessories, with a focus on both efficiency and noise reduction. The system includes an interface integrated into the vehicle's infotainment system, allowing the driver to manually adjust energy settings. The interface provides the option to select from predefined modes such as “Comfort” or “Efficiency,” or to customize energy allocation according to specific priorities. In “Comfort” mode, the system gives priority to accessories that enhance passenger comfort, such as heating and cooling systems, while in “Efficiency” mode, the system limits the use of non-essential accessories to maximize the vehicle's range. The system also accounts for the impact of these adjustments on the noise levels of high-and low-voltage components, ensuring that comfort is maintained without generating excessive noise from powertrain elements.

In addition to these predefined modes, the system allows for further customization of energy allocation based on user preferences and specific driving conditions. For example, the driver can prioritize energy for specific accessories while driving in colder climates or during longer trips, where cabin heating or additional lighting might be necessary for safety or comfort. At the same time, the system ensures that any adjustments made to the power allocation do not negatively affect the noise levels generated by high-voltage systems, such as cooling fans or inverters, ensuring a smooth and quiet driving experience. This level of flexibility allows drivers to tailor energy consumption based on their needs, whether for maximizing efficiency or ensuring a high level of comfort without compromising NVH performance.

The system's ability to adjust energy allocation in real-time, manage noise from both high-and low-voltage systems, and offer multiple modes of user control is a significant advancement over traditional systems. Unlike conventional systems that rely on fixed power settings or provide limited user interaction, this system continuously monitors energy flow, providing real-time feedback and enabling adaptive energy management. By managing both power consumption and noise levels across high-and low-voltage systems, the system ensures that the vehicle operates at peak efficiency, balancing energy needs with minimal acoustic disruption.

By integrating the energy overview system with the vehicle's powertrain and providing an intuitive user interface, the system represents a comprehensive solution to energy management. The ability to dynamically adjust accessory power usage, manage noise from both high-and low-voltage systems, and provide real-time insights into energy usage ensures a balance between efficiency, performance, and acoustic comfort. This approach not only extends the vehicle's range but also enhances the overall user experience, allowing drivers to make informed decisions about energy consumption while maintaining a quiet and optimal vehicle operation. The system's adaptability to varying driving conditions, coupled with its user-friendly interface, makes it a key advancement in modern energy-efficient vehicle design.

Overall system optimization in an EV is useful for achieving peak performance, efficiency, and reliability. This process involves the integration and fine-tuning of key powertrain components, including the battery, electric motor, power electronics, and control systems. Among these, the inverter plays an important role by converting DC from the battery into AC required by the electric motor. The optimization of inverter control is therefore essential to ensure the seamless operation of the entire system under various conditions.

The inverter serves as the interface between the battery and the electric motor, regulating the flow of electrical energy. Its control system must dynamically manage power delivery to match the requirements of driving conditions. This is achieved through a process known as inverter control mapping, which involves the precise calibration of several operational parameters. These parameters include switching frequency, pulse width modulation (PWM) strategies, and voltage and current limits, all of which are adjusted to balance performance, efficiency, and thermal stability.

Switching frequency refers to the rate at which the inverter turns its power transistors on and off to deliver electrical energy to the motor. Higher switching frequencies can reduce harmonic distortion in the motor's electrical signals, leading to improved efficiency and smoother operation. However, increasing the frequency also introduces challenges, such as elevated switching losses and greater thermal stress on components. Optimal frequency selection is therefore a useful tradeoff between minimizing losses and ensuring durability.

PWM is a key technique used to modulate the voltage and current supplied to the electric motor. By varying the width of the voltage pulses, the inverter precisely controls the motor's power output. Accurate PWM implementation is essential for smooth torque delivery, which translates to improved driving comfort and reduced vibration. Furthermore, efficient PWM strategies can minimize power losses and improve the motor's overall energy efficiency.

Voltage and current limits are set to safeguard the motor and inverter against electrical or thermal damage. Overvoltage or overcurrent conditions can arise due to sudden changes in load or system faults. By implementing advanced control algorithms, the system dynamically monitors and adjusts these parameters to prevent failures, ensuring safe operation while maintaining performance under varying load conditions.

To enhance the adaptability and performance of the EV traction system, a multi-level control architecture is implemented. This hierarchical structure comprises high-level, mid-level, and low-level controls, each focusing on distinct aspects of optimization. By distributing control functions across these levels, the system achieves robust and precise operation across a wide range of driving scenarios.

High-level controls govern overall system behavior. Mode selection allows the driver to choose between eco, normal, and sport modes, each calibrated for specific performance objectives. For instance, eco mode prioritizes efficiency and range, while sport mode emphasizes rapid acceleration and maximum power output. Energy management further optimizes electrical energy distribution among the battery, motor, and auxiliary systems. Advanced regenerative braking strategies are incorporated at this level to maximize energy recovery during deceleration.

Mid-level controls focus on managing motor behavior in response to real-time driving inputs and environmental conditions. Torque control regulates the motor's torque output based on the driver's acceleration demands and vehicle dynamics, ensuring smooth and responsive operation. Speed control, on the other hand, maintains a constant vehicle speed by adjusting the motor's power output, which is useful for cruise control and adaptive speed functions.

Low-level controls operate directly on electrical and thermal parameters to ensure system stability and reliability. Current control adjusts the instantaneous current supplied to the motor, enabling precise torque generation while minimizing electrical losses. Thermal management systems continuously monitor the temperature of useful components such as the inverter and motor. Active cooling strategies and derating mechanisms are deployed as necessary to prevent overheating and prolong component life.

The multi-level control framework enables the EV traction system to operate in various modes tailored to specific driving conditions. In normal mode, the system balances efficiency and performance for everyday driving. Eco mode extends range by optimizing energy consumption and enhancing regenerative braking. Sport mode delivers maximum power output and rapid acceleration by relaxing efficiency constraints. Regenerative braking mode focuses on energy recovery, using precise inverter controls to convert kinetic energy into stored electrical energy during deceleration.

Regenerative braking represents a sophisticated aspect of inverter control. The system dynamically adjusts braking torque to maximize energy recovery without compromising vehicle stability. Advanced algorithms ensure smooth transitions between mechanical and regenerative braking, improving driving comfort. This mode significantly enhances the overall energy efficiency of the EV, particularly during urban driving with frequent stop-and-go conditions.

Optimization enhances the performance, efficiency, and reliability of the EV, providing a superior driving experience. This disclosure is applicable to all electrified vehicles, including BEVs, HEVs, and PHEVs, where energy management for accessory loads is useful. The system enhances user experience by providing transparency in energy usage while ensuring vehicle efficiency and performance are maintained.

The optimization of the EV traction system requires a holistic approach that combines precise inverter control with a hierarchical multi-level control architecture. By calibrating switching frequency, PWM strategies, and protective limits, the inverter is tailored to meet the demands of various driving scenarios. High-, mid-, and low-level controls work synergistically to enhance performance, reliability, and efficiency. The adoption of such advanced control strategies ensures that the EV operates effectively across diverse operating modes, providing a seamless and energy-efficient driving experience.

In electrified vehicles, the operation modes such as “Comfort” and “Efficiency” provide different strategies for managing energy usage, and these modes have significant effects on NVH levels. When the vehicle is in “Comfort” mode, the system prioritizes energy allocation to accessories that enhance passenger comfort, such as HVAC systems, and seat heaters. These comfort-related accessories require substantial amounts of energy, particularly HVAC systems, which can create both thermal and acoustic noise. As the system operates these accessories at full capacity to maintain a comfortable cabin environment, the increased load on the powertrain components, such as the high-voltage battery, inverters, and cooling fans, can result in higher noise levels, especially in high-voltage systems where cooling fans and thermal management systems often produce more sound.

The increased power demands in “Comfort” mode can affect NVH performance as the vehicle's powertrain adjusts to supply the necessary energy. High-load components, such as the cooling fans and inverters, which are typically used for managing the powertrain's thermal and electrical efficiency, can generate increased noise in this mode. These noise emissions may be particularly noticeable during low-speed or idle conditions, where the noise from internal accessories becomes more perceptible relative to the quieter sounds from the road or external environment. The system may also adjust power to components like the HVAC system to ensure a stable energy supply, potentially amplifying noise from air-moving parts like fans and compressors. The system may also have to modulate higher voltage systems more aggressively, which can lead to more noticeable acoustic output in the cabin, creating a tradeoff between comfort and noise levels.

On the other hand, when the vehicle is switched to “Efficiency” mode, the system limits the use of non-essential accessories to maximize the vehicle's range. By reducing the demand for comfort-related systems like HVAC and seat heaters, the system minimizes the power draw from the vehicle's high-voltage systems. This reduction in power consumption helps conserve battery energy, allowing the vehicle to achieve longer distances on a single charge. With fewer high-power accessories operating, the strain on high-voltage components such as inverters and cooling fans is decreased, leading to lower overall noise levels. In particular, the reduced operation of cooling fans and less frequent use of the HVAC system directly impacts NVH performance by minimizing noise from thermal management systems. This mode often results in a quieter cabin environment due to lower powertrain activity, with fewer active components generating noise.

The NVH characteristics in “Efficiency” mode are influenced by the vehicle's powertrain dynamics, which are adjusted to optimize energy conservation. In this mode, the powertrain typically operates at a more balanced and lower energy consumption state, reducing the load on high-voltage systems and thereby minimizing their noise emissions. With less demand for thermal management and accessory power, the vehicle is likely to produce a more serene driving experience, with less distraction from mechanical sounds. Additionally, in “Efficiency” mode, the system may limit the speed of certain high-voltage components like cooling fans, resulting in lower fan noise and reducing the overall noise profile within the cabin.

Both “Comfort” and “Efficiency” modes introduce tradeoffs between energy usage and NVH levels. “Comfort” mode, by allowing the HVAC system and other energy-intensive accessories to operate at full capacity, may lead to higher NVH due to the increased energy draw on high-voltage systems and more active thermal management. However, “Efficiency” mode offers a more optimized approach by reducing the power consumption of these systems, resulting in quieter operation but potentially sacrificing some passenger comfort, especially in extreme weather conditions. The system's ability to dynamically manage energy distribution based on these modes provides a flexible approach to balancing comfort, energy efficiency, and NVH, allowing the driver to choose the mode best suited to their preferences or driving conditions.

In the context of NVH, the concept of masking refers to the phenomenon where a dominant noise source effectively hides or reduces the perceptibility of secondary, less intense noises. This occurs when a more prominent noise—often louder or of a similar frequency range—distracts the listener's attention and diminishes the prominence of other, quieter sounds that might otherwise be noticeable. Masking plays a significant role in vehicle acoustics, particularly in electrified vehicles where NVH characteristics are carefully managed to ensure passenger comfort and reduce unwanted noise.

The relationship between masking and the vehicle's drive modes, such as “Comfort” and “Efficiency,” is useful for optimizing NVH performance. For instance, in “Comfort” mode, the vehicle prioritizes energy for comfort-related accessories, such as HVAC systems. The increased demand for power from these systems results in greater energy use from the powertrain components, like cooling fans or inverters, which can produce additional noise. In this mode, however, road noise or tire noise, which often dominates at higher speeds, may mask the hum or whine of the electric motor, HVAC systems, or other secondary noises. The dominant road noise effectively masks quieter secondary noises, allowing the vehicle to maintain a comfortable cabin environment despite the increased load on powertrain components.

On the other hand, in “Efficiency” mode, the system limits the operation of non-essential accessories to conserve energy and maximize the vehicle's range. This reduction in energy use can lower the overall noise generated by high-voltage systems, such as cooling fans or inverters, which are less active. However, as the vehicle operates with fewer high-power accessories, road noise may become more noticeable, especially at higher speeds. In this mode, the vehicle may rely more on the inherent masking effects of road and tire noise to hide the quieter sounds from thermal management systems, reducing the impact of secondary NVH sources. The reduced load on the powertrain in “Efficiency” mode may result in a quieter operation overall, but masking dynamics could shift as different sounds become more or less prominent depending on the drive conditions.

The concept of masking can also be leveraged by the vehicle's systems to enhance the passenger experience. In both “Comfort” and “Efficiency” modes, the system may adjust the allocation of energy between the high-voltage powertrain and low-voltage accessories, strategically managing the tradeoff between comfort and NVH. For example, when the vehicle is in “Comfort” mode and the HVAC system is running at full capacity, the increased fan speed and compressor load might produce higher levels of noise. The vehicle's systems may take advantage of the masking effect by ensuring that the background road noise, which tends to dominate at higher speeds, helps obscure the noise from these active components. This reduces the perception of unwanted noise from the HVAC system, allowing the vehicle to maintain a balance between comfort and NVH performance.

Moreover, the dynamic changes in masking caused by varying levels of energy consumption in different drive modes can enhance the vehicle's acoustic environment. In “Comfort” mode, when accessories like HVAC and seat heaters are operating at their full potential, the system can leverage the masking effect to reduce the prominence of any secondary noises coming from the powertrain. Conversely, in “Efficiency” mode, while quieter operation of high-voltage components reduces some noise, the overall quieter environment may make secondary noises more noticeable at low speeds or during stops. The system's ability to adjust energy allocation based on these modes helps optimize both efficiency and comfort, while carefully managing the acoustic experience for the passengers.

In conclusion, masking plays an useful role in managing NVH in electrified vehicles, and its relationship with drive modes such as “Comfort” and “Efficiency” is essential to creating a pleasant and balanced cabin environment. By understanding how dominant noises like road noise can mask secondary noises from the powertrain or HVAC systems, vehicle engineers can design systems that enhance comfort and minimize distractions. In “Comfort” mode, the masking of secondary noises by road noise helps mitigate the impact of higher power demands, while in “Efficiency” mode, the vehicle reduces noise from non-essential systems while allowing road noise to play a more prominent role in masking any remaining secondary noises. This dynamic interplay between masking and drive modes ensures an optimal NVH experience for the driver and passengers in various driving conditions.

A “high-performance mode” in an EV, whether hybrid or fully electric, is a specialized driving mode designed to maximize the power output from the electric motor(s) to enhance acceleration, responsiveness, and top speed. This mode optimizes multiple vehicle parameters, including motor control, torque delivery, and the distribution of energy from the vehicle's power source to various components, ensuring that the vehicle can meet the driver's demand for immediate performance. Activated through a dedicated control on the dashboard or center console, high-performance mode allows the driver to access the full potential of the vehicle's powertrain. In addition to motor control adjustments, the mode may also modify suspension settings and regenerative braking to further improve driving dynamics.

To maximize performance, high-performance mode increases the power delivered from the battery or other energy storage systems to the motor(s). The energy from the vehicle's power source, typically a lithium-ion battery, is distributed to the motor through the inverter, which converts the DC from the battery into AC required by the motor. In high-performance mode, the inverter may adjust its switching frequency to optimize the conversion process, ensuring the motor operates at peak efficiency and can deliver aggressive torque outputs with minimal delay. This allows for rapid acceleration and improved responsiveness, particularly when the driver demands immediate power, such as during high-speed overtaking or fast starts.

The vehicle's computer system plays a useful role in high-performance mode by dynamically adjusting motor control parameters. These adjustments include changes in torque delivery, where more immediate power is directed to the wheels based on throttle input. The energy from the battery is routed more aggressively to the inverter and motor(s) to maximize performance while ensuring that the system remains within safe operational limits. By increasing the voltage and current sent to the motor, the vehicle provides a much higher power output than in standard driving modes, enhancing acceleration and responsiveness. This distribution of energy allows the vehicle to achieve faster 0-60 mph times and better performance on demanding road conditions.

In addition to adjusting power delivery to the motor, high-performance mode also involves alterations to other components of the vehicle. For instance, the suspension system may be re-tuned for a firmer, sportier feel, ensuring better stability during aggressive cornering and high-speed maneuvers. The energy used to power these adjustments may be drawn from the same power source, with electric actuators adjusting suspension stiffness and damping rates in real-time. Additionally, energy required for auxiliary systems, such as power steering or active aerodynamics, may be redistributed to ensure these systems perform optimally without compromising the vehicle's power output. By efficiently managing how energy is allocated between these systems, the vehicle maximizes handling and performance.

While energy is directed to the motor for increased acceleration, high-performance mode also adjusts the vehicle's regenerative braking system. Regenerative braking recovers kinetic energy during deceleration, converting it back into electrical energy and storing it in the battery. In high-performance mode, the regenerative braking system may be tuned to either increase or decrease braking force, allowing for sharper deceleration and energy recovery when necessary. This dynamic adjustment ensures the vehicle can provide precise control when slowing down, further enhancing the driving experience while still ensuring energy efficiency by capturing energy during braking. This system plays a useful role in maintaining optimal performance without the need for excessive reliance on the braking system.

One of the tradeoffs of engaging high-performance mode is its impact on the vehicle's driving range. As energy is routed to the motor for performance optimization, battery consumption increases, resulting in a faster depletion of the battery charge. This is because more energy is being used to power the motor at higher output levels, reducing the overall efficiency of the vehicle. The power distribution to the motor during high-performance mode demands more energy than in standard modes, and thus the driving range may be reduced significantly. However, this tradeoff is expected, as the driver has the option to choose performance over range in specific driving scenarios that require heightened power and responsiveness.

To ensure the battery remains within safe thermal limits while providing high levels of power, thermal management systems are also an essential component of high-performance mode. The battery and motor produce heat during high-performance operation, and energy may be redirected to cooling systems to maintain optimal operating temperatures. This is especially useful in extended high-performance driving situations, where excessive heat buildup could degrade performance or damage useful components. Cooling systems, powered by energy from the vehicle's power source, may actively manage battery temperature, ensuring that the powertrain can continue to deliver high-performance without thermal limitations. By managing the distribution of energy to cooling systems and motor components, high-performance mode helps maintain both power and longevity of the vehicle.

In high-performance mode, the vehicle's energy management system prioritizes power delivery, torque control, and regenerative braking adjustments to ensure that the driver's demand for immediate performance is met. The system makes real-time adjustments to allocate energy across components, including the motor, suspension, steering, and auxiliary systems, ensuring that all elements of the vehicle are optimized for performance. The redistribution of energy to these systems allows the driver to experience a more dynamic and responsive vehicle without compromising safety or stability. The flexibility of the energy distribution system allows for a customized driving experience, balancing power, handling, and overall performance.

In summary, high-performance mode in an electrified vehicle maximizes the power output from the vehicle's energy source by optimizing the distribution of energy to key components, including the motor, suspension, and regenerative braking systems. By increasing power to the motor, modifying torque delivery, and adjusting auxiliary systems, high-performance mode enhances acceleration, responsiveness, and handling. However, this comes with a tradeoff in reduced driving range, as more energy is consumed to achieve higher performance levels. The vehicle's energy management system plays a useful role in ensuring that energy is efficiently allocated to different systems, balancing performance with the need for thermal management and stability. High-performance mode provides an exhilarating driving experience by enabling the vehicle to meet the demands of the driver for immediate and powerful performance.

A “high-performance mode” in an EV, whether hybrid or fully electric, is a specialized driving mode designed to maximize the power output from the electric motor(s) to enhance acceleration, responsiveness, and top speed. This mode optimizes multiple vehicle parameters, including motor control, torque delivery, and the distribution of energy from the vehicle's power source to various components, ensuring that the vehicle can meet the driver's demand for immediate performance. Activated through a dedicated control on the dashboard or center console, high-performance mode allows the driver to access the full potential of the vehicle's powertrain. In addition to motor control adjustments, the mode may also modify suspension settings and regenerative braking to further improve driving dynamics.

To maximize performance, high-performance mode increases the power delivered from the battery or other energy storage systems to the motor(s). The energy from the vehicle's power source, typically a lithium-ion battery, is distributed to the motor through the inverter, which converts the DC from the battery into AC required by the motor. In high-performance mode, the inverter may adjust its switching frequency to optimize the conversion process, ensuring the motor operates at peak efficiency and can deliver aggressive torque outputs with minimal delay. This allows for rapid acceleration and improved responsiveness, particularly when the driver demands immediate power, such as during high-speed overtaking or fast starts.

The vehicle's computer system plays a useful role in high-performance mode by dynamically adjusting motor control parameters. These adjustments include changes in torque delivery, where more immediate power is directed to the wheels based on throttle input. The energy from the battery is routed more aggressively to the inverter and motor(s) to maximize performance while ensuring that the system remains within safe operational limits. By increasing the voltage and current sent to the motor, the vehicle provides a much higher power output than in standard driving modes, enhancing acceleration and responsiveness. This distribution of energy allows the vehicle to achieve faster 0-60 mph times and better performance on demanding road conditions.

In addition to adjusting power delivery to the motor, high-performance mode also involves alterations to other components of the vehicle. For instance, the suspension system may be re-tuned for a firmer, sportier feel, ensuring better stability during aggressive cornering and high-speed maneuvers. The energy used to power these adjustments may be drawn from the same power source, with electric actuators adjusting suspension stiffness and damping rates in real-time. Additionally, energy required for auxiliary systems, such as power steering or active aerodynamics, may be redistributed to ensure these systems perform optimally without compromising the vehicle's power output. By efficiently managing how energy is allocated between these systems, the vehicle maximizes handling and performance.

While energy is directed to the motor for increased acceleration, high-performance mode also adjusts the vehicle's regenerative braking system. Regenerative braking recovers kinetic energy during deceleration, converting it back into electrical energy and storing it in the battery. In high-performance mode, the regenerative braking system may be tuned to either increase or decrease braking force, allowing for sharper deceleration and energy recovery when necessary. This dynamic adjustment ensures the vehicle can provide precise control when slowing down, further enhancing the driving experience while still ensuring energy efficiency by capturing energy during braking. This system plays a useful role in maintaining optimal performance without the need for excessive reliance on the braking system.

One of the tradeoffs of engaging high-performance mode is its impact on the vehicle's driving range. As energy is routed to the motor for performance optimization, battery consumption increases, resulting in a faster depletion of the battery charge. This is because more energy is being used to power the motor at higher output levels, reducing the overall efficiency of the vehicle. The power distribution to the motor during high-performance mode demands more energy than in standard modes, and thus the driving range may be reduced significantly. However, this tradeoff is expected, as the driver has the option to choose performance over range in specific driving scenarios that require heightened power and responsiveness.

To ensure the battery remains within safe thermal limits while providing high levels of power, thermal management systems are also an essential component of high-performance mode. The battery and motor produce heat during high-performance operation, and energy may be redirected to cooling systems to maintain optimal operating temperatures. This is especially useful in extended high-performance driving situations, where excessive heat buildup could degrade performance or damage useful components. Cooling systems, powered by energy from the vehicle's power source, may actively manage battery temperature, ensuring that the powertrain can continue to deliver high-performance without thermal limitations. By managing the distribution of energy to cooling systems and motor components, high-performance mode helps maintain both power and longevity of the vehicle.

In high-performance mode, the vehicle's energy management system prioritizes power delivery, torque control, and regenerative braking adjustments to ensure that the driver's demand for immediate performance is met. The system makes real-time adjustments to allocate energy across components, including the motor, suspension, steering, and auxiliary systems, ensuring that all elements of the vehicle are optimized for performance. The redistribution of energy to these systems allows the driver to experience a more dynamic and responsive vehicle without compromising safety or stability. The flexibility of the energy distribution system allows for a customized driving experience, balancing power, handling, and overall performance.

Masking concepts discussed elsewhere herein can be incorporated across these drive modes to achieve the specific goals of each drive mode while also considering NVH. For instance, high-performance mode in an electrified vehicle maximizes the power output from the vehicle's energy source by optimizing the distribution of energy to key components, including the motor, suspension, and regenerative braking systems. By increasing power to the motor, modifying torque delivery, and adjusting auxiliary systems, high-performance mode enhances acceleration, responsiveness, and handling. However, this comes with a tradeoff in reduced driving range, as more energy is consumed to achieve higher performance levels. The vehicle's energy management system plays a useful role in ensuring that energy is efficiently allocated to different systems, balancing performance with the need for thermal management and stability. High-performance mode provides an exhilarating driving experience by enabling the vehicle to meet the demands of the driver for immediate and powerful performance. Performance of components can be elevated while still constituting secondary noise levels relative to the dominant noise.

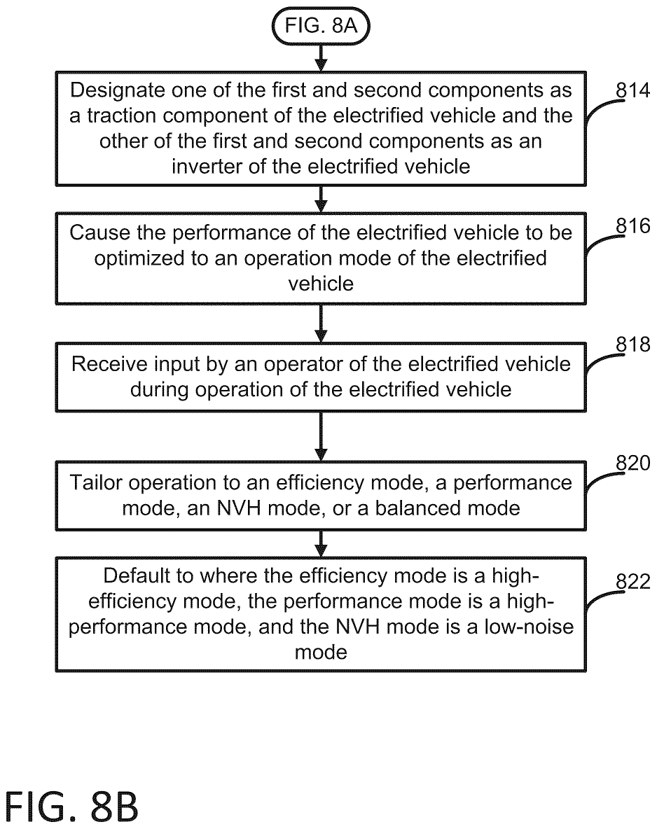

FIG. 8 is a flowchart of an example method 800. In some implementations, one or more process blocks of FIG. 8 may be performed by an apparatus.

As shown in FIG. 8, method 800 may include receiving an indication of a dominant disturbance associated with operation of a first component of the electrified vehicle, the dominant disturbance having a dominant noise level associated therewith (block 802). For example, apparatus may receive an indication of a dominant disturbance associated with operation of a first component of the electrified vehicle, the dominant disturbance having a dominant noise level associated therewith, as described above. As also shown in FIG. 8, method 800 may include adjusting operation of a second component of the electrified vehicle having a secondary noise level associated therewith at least so long as the secondary noise level is less than the dominant noise level such that performance of the electrified vehicle is optimized without detrimentally affecting the sensory feedback associated with the performance (block 804). For example, apparatus may adjust operation of a second component of the electrified vehicle having a secondary noise level associated therewith at least so long as the secondary noise level is less than the dominant noise level such that performance of the electrified vehicle is optimized without detrimentally affecting the sensory feedback associated with the performance, as described above.

Process 800 may include additional implementations, such as any single implementation or any combination of implementations described below and/or in connection with one or more other processes described elsewhere herein. In a first implementation, the adjusting is subject to a safety criterion associated with vehicle safety conditions and vehicle safety operations.

In a second implementation, alone or in combination with the first implementation, the safety criterion is related to at least one of a vehicle speed and a vehicle location.

In a third implementation, alone or in combination with the first and second implementation, the vehicle safety conditions include at least one of low noise during low-speed operation of the electrified vehicle, a charging operation to charge the electrified vehicle, and a location or proximity to a safety zone or safety vehicle.

In a fourth implementation, alone or in combination with one or more of the first through third implementations, the adjusting operation of the second component of the electrified vehicle having the secondary noise level associated therewith includes causing the second component to operate at a level that produces otherwise more objectionable noise than before the adjustment.

In a fifth implementation, alone or in combination with one or more of the first through fourth implementations, either of the first and second components is a traction component of the electrified vehicle and the other of the first and second components is an inverter of the electrified vehicle.

In a sixth implementation, alone or in combination with one or more of the first through fifth implementations, the adjusting causes the performance of the electrified vehicle to be optimized to an operation mode of the electrified vehicle.

In a seventh implementation, alone or in combination with one or more of the first through sixth implementations, the operation mode of the electrified vehicle is selectable by an operator of the electrified vehicle during operation of the electrified vehicle.

In an eighth implementation, alone or in combination with one or more of the first through seventh implementations, the operation mode of the electrified vehicle is at least one of an efficiency mode, a performance mode, an NVH mode, and a balanced mode.

In a ninth implementation, alone or in combination with one or more of the first through eighth implementations, the efficiency mode is a high-efficiency mode, the performance mode is a high-performance mode, and the NVH mode is a low-noise mode.

Although FIG. 8 shows example blocks of method 800, in some implementations, method 800 may include additional blocks, fewer blocks, different blocks, or differently arranged blocks than those depicted in FIG. 8. Additionally, or alternatively, two or more of the blocks of method 800 may be performed in parallel.

FIGS. 8A and 8B together show a flowchart of an example method 800. In some implementations, one or more process blocks of FIG. 8 may be performed by an apparatus, such as devices and systems disclosed elsewhere herein.

As shown in FIG. 8, method 800 may include receiving an indication of a dominant disturbance associated with operation of a first component of the electrified vehicle, the dominant disturbance having a dominant noise level associated therewith (block 802). For example, apparatus may receive an indication of a dominant disturbance associated with operation of a first component of the electrified vehicle, the dominant disturbance having a dominant noise level associated therewith, as described above. As also shown in FIG. 8, method 800 may include adjusting operation of a second component of the electrified vehicle having a secondary noise level associated therewith at least so long as the secondary noise level is less than the dominant noise level such that performance of the electrified vehicle is optimized without detrimentally affecting the sensory feedback associated with the performance (block 804). For example, apparatus may adjust operation of a second component of the electrified vehicle having a secondary noise level associated therewith at least so long as the secondary noise level is less than the dominant noise level such that performance of the electrified vehicle is optimized without detrimentally affecting the sensory feedback associated with the performance, as described above.

Method 800 may include additional implementations, such as any single implementation or any combination of implementations described below and/or in connection with one or more other processes described elsewhere herein. In a first implementation, the adjusting is subject to a safety criterion associated with vehicle safety conditions and vehicle safety operations (block 806).

In a second implementation, alone or in combination with the first implementation, the safety criterion is related to at least one of a vehicle speed and a vehicle location (block 808).

In a third implementation, alone or in combination with the first and second implementation, the vehicle safety conditions include at least one of low noise during low-speed operation of the electrified vehicle, a charging operation to charge the electrified vehicle, and a location or proximity to a safety zone or safety vehicle (block 810).

In a fourth implementation, alone or in combination with one or more of the first through third implementations, the adjusting operation of the second component of the electrified vehicle having the secondary noise level associated therewith includes causing the second component to operate at a level that produces otherwise more objectionable noise than before the adjustment (block 812).

In a fifth implementation, alone or in combination with one or more of the first through fourth implementations, either of the first and second components is a traction component of the electrified vehicle and the other of the first and second components is an inverter of the electrified vehicle (block 814).

In a sixth implementation, alone or in combination with one or more of the first through fifth implementations, the adjusting causes the performance of the electrified vehicle to be optimized to an operation mode of the electrified vehicle (block 816).

In a seventh implementation, alone or in combination with one or more of the first through sixth implementations, the operation mode of the electrified vehicle is selectable by an operator of the electrified vehicle during operation of the electrified vehicle (block 818).

In an eighth implementation, alone or in combination with one or more of the first through seventh implementations, the operation mode of the electrified vehicle is at least one of an efficiency mode, a performance mode, an NVH mode, and a balanced mode (block 820).

In a ninth implementation, alone or in combination with one or more of the first through eighth implementations, the efficiency mode is a high-efficiency mode, the performance mode is a high-performance mode, and the NVH mode is a low-noise mode (block 822).

Although FIGS. 8A and 8B show example blocks of method 800, in some implementations, Method 800 may include additional blocks, fewer blocks, different blocks, or differently arranged blocks than those depicted in FIG. 8. Additionally, or alternatively, two or more of the blocks of Method 800 may be performed in parallel.

It is well understood that methods that include one or more steps, the order listed is not a limitation of the claim unless there are explicit or implicit statements to the contrary in the specification or claim itself. It is also well settled that the illustrated methods are just some examples of many examples disclosed, and certain steps can be added or omitted without departing from the scope of this disclosure. Such steps can include incorporating devices, systems, or methods or components thereof as well as what is well understood, routine, and conventional in the art.

The connecting lines shown in the various figures contained herein are intended to represent exemplary functional relationships and/or physical couplings between the various elements. It should be noted that many alternative or additional functional relationships or physical connections can be present in a practical system. However, the benefits, advantages, solutions to problems, and any elements that can cause any benefit, advantage, or solution to occur or become more pronounced are not to be construed as useful, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone can be present in an embodiment, B alone can be present in an embodiment, C alone can be present in an embodiment, or that any combination of the elements A, B or C can be present in a single embodiment; for example, A and B, A and C, B and C, or A and B and C.

In the detailed description herein, references to “one embodiment,” “an embodiment,” “an example embodiment,” etc., indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus.

While various embodiments of the disclosure have been shown and described, it is understood that these embodiments are not limited thereto. The embodiments may be changed, modified and further applied by those skilled in the art. Therefore, these embodiments are not limited to the detail shown and described previously, but also include all such changes and modifications.

What is claimed is

1. A method of dynamically optimizing performance and sensory feedback of an electrified vehicle, the method comprising:
receiving an indication of a dominant disturbance associated with operation of a first component of the electrified vehicle, the dominant disturbance having a dominant noise level associated therewith; and
adjusting operation of a second component of the electrified vehicle having a secondary noise level associated therewith at least so long as the secondary noise level is less than the dominant noise level such that performance of the electrified vehicle is optimized without detrimentally affecting the sensory feedback associated with the performance.

2. The method of claim 1, wherein the adjusting is subject to a safety criterion associated with vehicle safety conditions and vehicle safety operations.

3. The method of claim 2, wherein the vehicle safety operations includes at least one of a passenger pickup operation, a signage deployment operation, and a safety component deployment operation.

4. The method of claim 2, wherein the safety criterion is related to at least one of a vehicle speed and a vehicle location.

5. The method of claim 4, wherein the vehicle safety conditions include at least one of low noise during low-speed operation of the electrified vehicle, a charging operation to charge the electrified vehicle, and a location or proximity to a safety zone or safety vehicle.

6. The method of claim 1, wherein the adjusting operation of the second component of the electrified vehicle having the secondary noise level associated therewith includes causing the second component to operate at a level that produces otherwise more objectionable noise than before the adjustment.

7. The method of claim 1, wherein either of the first and second components is a traction component of the electrified vehicle and the other of the first and second components is an inverter of the electrified vehicle.

8. The method of claim 1, wherein the adjusting causes the performance of the electrified vehicle to be optimized to an operation mode of the electrified vehicle.

9. The method of claim 8, wherein the operation mode of the electrified vehicle is selectable by an operator of the electrified vehicle during operation of the electrified vehicle.

10. The method of claim 8, wherein the operation mode of the electrified vehicle is at least one of an efficiency mode, a performance mode, an NVH mode, and a balanced mode.

11. The method of claim 10, wherein the efficiency mode is a high-efficiency mode, the performance mode is a high-performance mode, and the NVH mode is a low-noise mode.

12. A system to promote real-time operational adjustments of a first component that is operationally connected with a power source in concert with a second component that is operationally connected with the power source, the first component operating so as to produce a dominant noise level relative to the second component, the system being configured to adjust an operation of the second component based on both the dominant noise level and a sensory feedback criterion.

13. The system of claim 12, wherein the system is integrable into an electrified vehicle, and wherein either of the first and second components is a traction component of the electrified vehicle and the other of the first and second components is an inverter of the electrified vehicle, and the adjustment includes causing the second component to operate at a level that produces otherwise more objectionable noise than before the adjustment.

14. The system of claim 12, wherein the adjustment is subject to a safety criterion associated with vehicle safety conditions and vehicle safety operations.

15. The system of claim 14, wherein the power source is an electrified vehicle, wherein the adjustment causes the performance of the electrified vehicle to be optimized to an operation mode of the electrified vehicle, and wherein the operation mode of the electrified vehicle is selectable by the operator of the electrified vehicle during operation of the electrified vehicle.

16. The system of claim 15, wherein the system is integrated into the electrified vehicle, wherein the dominant noise level is caused by a driver demand, and wherein a sensory feedback criterion to which the adjustments are tailored conforms to an NVH standard or regulation for the electrified vehicle.

17. The system of claim 12, wherein the power source is a charging station for an electrified vehicle or a generator.

18. A controller configured to monitor sensory feedback of a power source and energy flow through a circuitry that operatively connects components of the power source, and dynamically allocate energy from the power source to the components based on both a dominant noise level among components of the power source and a sensory feedback criterion.

19. The controller of claim 18, wherein the controller uses a model to dynamically allocate the energy according to a predetermined mapping of the components.

20. The controller of claim 19, wherein the model is configured to tailor the allocations based on at least one of input at an interface for displaying real-time energy usage, input at the interface to select a desired operation mode of the power source, input at the interface to select a desired sensory feedback level of the power source, and historical trends of operation the inputs or operation of the power source.
